(19) United States
(12) Patent Application Publication
(10) Pub. No.: US 2026/0209566 A1
(43) Pub. Date: Jul. 23, 2026

(54) ELECTRONIC ARTICLE HAVING INTERLAYER ADHESIVE LAYER WITH DAMPING/SHOCK-ABSORPTION FUNCTION

(71) Applicants: DOW SILICONES CORPORATION, Midland, MI (US); DOW TORAY CO., LTD., Shinagawa-Ku, Tokyo (JP)

(72) Inventors: Qing CAO, Shanghai (CN); Maki ITOH, Ichihara-shi, Chiba (JP); Jingui JIANG, Shanghai (CN); Bizhong ZHU, Auburn, MI (US); Michitaka SUTO, Ichihara-shi, Chiba (JP)

(21) Appl. No.: 19/142,191

(22) PCT Filed: Dec. 23, 2022
(86) PCT No.: PCT/CN2022/141212

§ 371 Date: Jun. 21, 2025

(51) Int. Cl. C09J 7/38; C09J 11/06; C09J 183/04

(52) U.S. Cl. CPC C09J 7/38; C09J 11/06; C09J 183/04; C09J 2203/326; C09J 2301/408; C09J 2301/50

(57) ABSTRACT

An electronic article having an interlayer adhesive layer, of which a temperature at tan δ peak is below 35° C., and tan δ value at peak is greater than 1.0, as measured by a dynamic mechanical analysis rheometer using a parallel plate measuring system at 1 Hz. In the electronic article of this disclosure, the interlayer adhesive layer is arranged between two functional layers to bond or assemble the two functional layers with providing impact resistance to the electronic article as a damping/shock-absorption layer. The electronic article of this disclosure can be a display device.

### CROSS REFERENCE TO RELATED APPLICATIONS

None.

### TECHNICAL FIELD

The present invention relates to an electronic article having an interlayer adhesive layer bonding/assembling functional layers with damping/shock-absorption function. In particular, the present invention relates to the electronic article (including the electronic device, equipment, part/module and unit) having an interlayer adhesive layer showing specific viscoelastic property in its tan δ curve measurement, and bonding/assembling functional layers of said electronic article with damping/shock-absorption function. This electronic article is useful in display device application having a structure that transparent displaying unit is directly bonded or assembled to other functional unit through said interlayer adhesive layer with providing impact resistance to the electronic article as a damping/shock-absorption layer. Preferably, said interlayer adhesive layer is a silicone-based pressure sensitive adhesive layer.

### BACKGROUND

Recent electronic articles (including the electronic device, equipment, part/module and unit; representatively, LED or OLED type display devices and its module thereof) consists of many functional layers and assumes a structure in which a film made up of a plurality of layers including an electrode layer and a display layer is sandwiched between substrates. To build/assemble such electronic articles, interlayer adhesive layer(s) are arranged between functional layers as “assembly layer” to bond/assemble said functional layers in the electronic articles. In particular, since silicone-based pressure sensitive adhesive (PSA) layer have excellent electrical insulating properties, heat resistance, cold resistance and adhesion to various adherends in comparison to acrylic or rubber based pressure sensitive adhesive compositions. Taking advantage of the above characteristics of polysiloxane pressure sensitive adhesives as well as characteristics which can achieve high transparency thereof as required, applications in the field of advanced electronic materials and display elements such as smart devices have been investigated in recent years. Furthermore, while Patent Documents 1 to 4 disclose properties in its tan δ curve for silicone-based PSA, there is no disclosure or suggestion of using single silicone-based PSA layer as interlayer assembly layer with damping/shock-absorption function in electronic articles like display devices.

On the other hand, to improve mechanical and electrical reliability with providing impact resistance to the electronic article, in traditional design of electronic articles (e.g. LED or OLED type display devices applied for automotive display, foldable display etc), foam tape (e.g., PU foam, PE foam or acrylic foam) or other interlayer damping or shock-absorption layer is applied as sandwiched between two adhesive layers to bond other functional layers (e.g. display layer and electrode layer) like following manner: [display layer/1^{st} adhesive layer/damping or shock-absorption layer/2^{nd} adhesive layer/electrode layer]. With the display electronics particularly the smartphone with OLED display becomes thinner and thinner, the interlayer damping or shock-absorption becomes more and more critical to protect screen from cracking during the drop test. For example, while Patent Documents 5 and 6 proposes using foam-sheet with silicone-based PSA layers or damping laminated body using silicone-based PSA layers, better damping ability for said damping or shock-absorption layer is required in the market. In addition, since a foam layer or other said damping or shock-absorption layer needs adhesive layers on the both sides to bond/assemble to other functional layers, it requires a multiple lamination process to build an electronic article (e.g. LED or OLED type display devices) and said electronic articles tend to get thick and weight with internally-multilayered damping or shock-absorption layer. Thus, to achieve thinner and light electronic article with better reliability, better and improved assembly layer is required in the market.

### RELATED ART DOCUMENTS

### Patent Documents

[Patent Document 1] WO2018149720A1
[Patent Document 2] WO2018149718A1
[Patent Document 3] WO2018149717A1
[Patent Document 4] JP2003313515A
[Patent Document 5] JP2019167484A
[Patent Document 6] JPH04-214341A

### SUMMARY

### Problems to be Solved

The present invention has been created in order to solve the abovementioned problems, and an object thereof is to provide an electronic article having thinner damping or shock-absorption layer to improve mechanical and electrical reliability with providing impact resistance to the electronic article, wherein its functional layers are tightly bonded or assembled in the electronic article. Also, an object of this invention is to provide a simplified manufacturing process for the electronic article in which does not require multiple lamination process to build its interlayer damping or shock-absorption layer. Furthermore, an object of this invention is to provide use of an interlayer adhesive layer in electronic articles as a damping/shock-absorption layer, wherein there is not any additional foam layers or damping/shock-absorption layers in the electronic articles.

### Means for Solving the Problem

As a result of conducting diligent research on the problems described above, the present inventors arrived at the present invention. That is, one object of the present invention is achieved by an electronic article having an interlayer adhesive layer, of which the temperature at the tan δ peak is below 35° C., and the tan δ value at the peak is greater than 1.0 is disclosed. When the tan δ curve is measured for said interlayer adhesive layer, the width of said tan δ peak of the interlayer adhesive layer, as defined by the absolute value of temperature range where the value of tan δ exceeds 0.5, is preferred to be narrower than 90° C. In this invention, said interlayer adhesive layer is preferred to be a pressure sensitive silicone adhesive layer obtained by curing a silicone-based pressure sensitive adhesive-forming composition comprises components (A) to (D):
(A) a linear organopolysiloxane having alkenyl group in numbers greater than 1 on average per molecule;
(B) an organopolysiloxane resin, wherein the total content of hydroxyl groups and hydrolysable groups with respect to all silicon atoms in molecules is 9 mole % or less;
(C) an organohydrogenpolysiloxane having at least two Si—H bonds per molecule; and
(D) a hydrosilylation reaction catalyst.

The electronic article of this invention comprises said interlayer adhesive layer arranged between two functional layers to bond or assemble said two functional layers with providing impact resistance to the electronic article as a damping/shock-absorption layer. Preferably, said electronic article of this invention is a display device.

This invention also provides a manufacturing process for the electronic article of this invention comprises a step of assembling or bonding at least two functional layers with an interlayer adhesive layer of which the temperature at the tan δ peak is below 35° C., and the tan δ value at the peak is greater than 1.0, as measured by a dynamic mechanical analysis rheometer using a parallel plate measuring system at 1 Hz.

This invention also provides use of an interlayer adhesive layer in electronic articles as a damping/shock-absorption layer, wherein the interlayer adhesive layer has a temperature at tan δ peak being below 35° C. and a tan δ value at the peak being greater than 1.0, as measured by a dynamic mechanical analysis rheometer using a parallel plate measuring system at 1 Hz.

### Effects of this Invention

Since said interlayer adhesive layer has sufficient adhesion for practical use to bond or assemble functional layers in the electronic article of this invention and also provide impact resistance to the electronic article as a damping/shock-absorption layer, the electronic article having thinner and light lamination structure can be constructed without using separate damping or shock-absorption layer other than said interlayer adhesive layer of the present invention. The electronic article of this invention shows better damping or shock-absorption layer to improve mechanical and electrical reliability with providing impact resistance to the electronic article. Additionally, since said interlayer adhesive layer in electronic article of this invention can be a single-coating layer having both assembly/bonding layer function and damping/shock-absorption layer function, the manufacturing process for the electronic article of this invention can be a simplified process not requiring multi-step lamination/coating process to build its interlayer damping or shock-absorption layer.

### BRIEF DESCRIPTION OF THE DRAWINGS

FIG. 1 shows a ball-dropping test result of laminated body using interlayer adhesive layer obtained by working example 7, in which no crack was observed at ball-contact point.

FIG. 2 shows a ball-dropping test result of laminated body using interlayer adhesive layer obtained by comparative example 1, in which clear crack was observed at ball-contact point.

### DETAILED DESCRIPTION

### Definition of Viscoelastic Properties Relating to Measured Tan δ Curve in Adhesive Layer

In this description, temperature at tan δ peak, temperature range (including its absolute value between two points of temperature in measured tan δ curve), tan δ value and other viscoelastic properties relating to measured tan δ curve for the interlayer adhesive layer means those as measured by a dynamic mechanical analysis rheometer using a parallel plate measuring system at 1 Hz.

### Structure of the Electronic Article

As described herein, the term “electronic article” may include electronic devices, electronic equipments and electronic parts/modules/units. First, the structure of the electronic article according to present invention will be described. The electronic article is characterized by having at least one interlayer adhesive layer, of which the temperature at the tan δ peak is below 35° C., and the tan δ value at the peak is greater than 1.0. In the electronic article, said interlayer adhesive layer is arranged between two functional layers to bond or assemble said two functional layers. Preferably, said electronic article is an LED or OLED type display device and its module thereof consisting of many functional layers and assumes a structure in which a laminated layers made up of a plurality of functional layers including an electrode layer and a display layer is sandwiched between substrates, wherein said functional layers are bonded or assembled with said interlayer adhesive layer. In a preferred form of the electronic article of this invention, said interlayer adhesive layer arranged between two functional layers, in which at least one of said functional layers can be substantively transparent. Also, since said interlayer adhesive layer have both assembly/bonding layer function and damping/shock-absorption layer function, the electronic article of this invention need not have further interlayer damping/shock-absorption layer arranged between two functional layers. For this bifunctional feature of said interlayer adhesive layer, through this invention, the electronic article can be constructed without using any additional interlayer damping/shock-absorption layer other than the interlayer adhesive layer between two functional layers.

Most preferably, the electronic article of this invention is an LED or OLED type display device and its module thereof having a structure that displaying unit is directly bonded or assembled to other functional unit with an interlayer adhesive layer, wherein the interlayer adhesive layer is a single adhesive/assembly layer sandwiched between said units in the display device. Since the display devices of this invention can be designed to be substantively free from interlayer damping/shock-absorption layer except for said interlayer adhesive layer (i.e. omitting thick and multi-layered damping/shock-absorption layer from the devices), the overall thickness of said display can be thinner and lighter in comparison with conventional devices.

The surface shape of such a display device may be a curved shape or a bowed shape rather than a flat surface, with examples thereof including curved displays or curved transmission screens used in automobiles (including electric vehicles), aircraft, or the like in addition to various flat panel displays (FPDs). Further, these display devices can display icons for executing functions or programs on a screen or display, notification indicators of e-mail, programs, or the like, and operation buttons for various devices such as car navigation devices, membranes for speakers, audio devices, and air conditioning devices, with touch panel functions enabling input operations capable of being added by touching these icons, notification indicators, or operation buttons with a finger. Application is possible as a device for CRT displays, liquid crystal displays, plasma displays, organic EL displays, inorganic EL displays, LED displays, surface electrolytic displays (SEDs), field emitting displays (FEDs), and other displaying devices, or touch panels using the displaying devices.

### Functions, Thickness and Viscoelastic Properties of Said Interlayer Adhesive Layer

In the electronic article of this invention, as a single layer having bifunctional feature, the interlayer adhesive layer has both assembly/bonding layer function and damping/shock-absorption layer function. That is to say, the interlayer adhesive layer has sufficient adhesive property to bond or assemble two functional layers in the electronic article and provide impact resistance to the electronic article as a damping/shock-absorption layer to improve mechanical and electrical reliability. Although the thickness of said interlayer adhesive layer is not limited and can be optimized by a person skilled in the art according to requirement, structure and size for the electronic article, preferred thickness of the interlayer adhesive layer ranges from 1 to 1000 μm, and more preferably from 10 to 500 μm, most preferably from 50 to 300 μm. When the thickness is below said lower limit, the adhesive force and damping/shock-absorption can be insufficient to achieve the purpose of this invention. On the other hand, the thickness exceeds said upper limit, thinner and lighter electronic article cannot be achieved for having thick interlayer adhesive layer.

To achieve said bifunctional feature in the interlayer adhesive layer for the electronic article of this invention, the interlayer adhesive layer meets the temperature at the tan δ peak below 35° C., below 30° C., below 25° C., below 20° C., or below 15° C., and the tan δ value at the peak is greater than 1.0, greater than 1.2, greater than 1.5, or greater than 1.7. Preferably tan δ value at the peak ranges from 1.00 to 4.00, 1.00 to 2.00 or 1.00 to 1.50, and the temperature at the tan δ peak is positioned from −70° C. to 25° C., from −60° C. to 20° C., from −50° C. to 15° C., from −40° C. to 10° C. or from −20° C. to 5° C. Furthermore, to achieve better damping/shock-absorption property in said interlayer adhesive layer, the width of said tan δ peak in the interlayer adhesive layer, as defined by the absolute value of temperature range where the value of tan δ exceeds 0.5, is narrower than 90° C., 80° C., 70° C., 60° C. or 50° C. For example, as measured by a dynamic mechanical analysis rheometer using a parallel plate measuring system at 1 Hz, when the value of tan δ exceeds 0.5 in a temperature range from −60° C. to 25° C. and tan δ peak is positioned between said temperature range, the width of said tan δ peak of the interlayer adhesive layer is defined to be 85° C. as an absolute value of said temperature range. In a similar manner, when the value of tan δ exceeds 0.5 in a temperature range from −50° C. to 15° C. and tan δ peak is positioned between said temperature ranges, the width of said tan δ peak of the interlayer adhesive layer is defined to be 65° C. as an absolute value of said temperature range. Preferably, the width of said tan δ peak in the interlayer adhesive layer ranges from 50 to below 90° C. to achieve better damping/shock-absorption property in said interlayer adhesive layer. On the other hand, when the width of said tan δ peak in the interlayer adhesive layer is 90° C. or more, the shape of tan δ peak is too broad to achieve sufficient damping/shock-absorption property with sufficient adhesion force for bonding/assembling functional layers in the electronic article. Most preferably, in this invention, the tan δ curve of the interlayer adhesive layer as measured by a dynamic mechanical analysis rheometer using a parallel plate measuring system at 1 Hz meets following conditions:
i) the temperature at the tan δ peak (preferably, tan δ value at the peak ranging from 1.00 to 2.50) is positioned from −70° C. to 25° C.; and
ii) the width of tan δ peak, as defined by the absolute value of temperature range where the value of tan δ exceeds 0.5, ranges from 50° C. to below 90° C.

In this invention, there is no limitation on material for said interlayer adhesive layer, and any type of adhesive materials can be applied to this invention to the extent that said interlayer adhesive layer is satisfying aforementioned viscoelastic property in its tan δ curve measurement. For example, at least one selected from silicone-based pressure sensitive adhesive (PSA), acrylic or rubber based adhesive, and polyurethane-based adhesive can be employed to apply in the electronic article of this invention as an interlayer adhesive layer having both assembly/bonding layer function and damping/shock-absorption layer function. Since silicone-based pressure sensitive adhesive (PSA) layer has excellent electrical insulating properties, heat resistance, cold resistance, and adhesion to various adherends in the electronic article, silicone-based PSA layer is preferably exemplified to apply as an interlayer adhesive layer in the electronic article of this invention.

### Silicone-Based PSA-Forming Composition

As one embodiment of this invention, said interlayer adhesive layer applied for the electronic article of this invention can be obtained by curing a silicone-based pressure sensitive adhesive-forming composition. The composition rapidly cures via a curing reaction containing a hydrosilylation reaction so as to form a pressure sensitive adhesive layer having sufficient adhesion for practical use and aforementioned viscoelastic properties relating to measured tan δ curve of the adhesive layer. Hereinafter, each component in the composition, the range of the organopolysiloxane resin, the mass ratio of the organopolysiloxane resin to linear organopolysiloxane, and the characteristics of the pressure sensitive adhesive layer will be described below.

As described above, the organopolysiloxane composition according to the present invention cures via a hydrosilylation reaction so as to form a pressure sensitive adhesive layer (having a certain adhesive force). In this composition, an organopolysiloxane resin with the sum of the content of hydroxyl groups and hydrolyzable groups with respect to all silicon atoms in the molecule is 9 mole % or less is used, and the range of formulation of the organopolysiloxane resin with respect to the chain organopolysiloxane (having alkenyl groups) serving as the main agent is within a specific range.

In an embodiment according to this invention, the organopolysiloxane composition for obtaining silicone-based PSA layer applied for this invention comprises components (A) to (E):
(A) a linear organopolysiloxane having alkenyl group in numbers greater than 1 on average per molecule;
(B) an organopolysiloxane resin, wherein the total content of hydroxyl groups and hydrolysable groups with respect to all silicon atoms in the molecule is 9 mole % or less;
(C) an organohydrogenpolysiloxane having at least two Si—H bonds in the molecule; and
(D) a hydrosilylation reaction catalyst.

In a further embodiment according to this invention, the silicone-based PSA-forming composition may further comprise (A′) a linear organopolysiloxane which does not contain a carbon-carbon double bond-containing reactive group in the molecule.

In addition, since the composition contains a hydrosilylation reaction catalyst, the composition may further contain (E) a curing retarder from the perspective of handleability, and may further contain other additives to such an extent that is not at odds with the object of the present invention. If required, at least one tetraalkoxysilane or a prepolymer of the tetraalkoxysilane as anchorage additive can be formulated to improve its adhesive force without affecting its rheological/viscoelastic properties.

In this invention, component (A) is a linear (i.e., chain-form) organopolysiloxane having alkenyl group in numbers greater than 1 on average per molecule, with a preferable number of alkenyl groups being no less than 1.5 per molecule, with a more preferable number of alkenyl groups being no less than 2.0 per molecule. In some embodiments according to this invention, the number of alkenyl groups on average per molecule may be in range from 1.01 to 5.0, from 1.01 to 4.0, from 1.01 to 3.0, from 1.01 to 2.0, from 1.01 to 1.5, from 1.5 to 5.0, from 1.5 to 4.0, from 1.5 to 3.0, from 1.5 to 2.0, from 2.0 to 5.0, from 2.0 to 4.0, from 2.0 to 3.0, from 3.0 to 5.0, from 3.0 to 4.0 or from 4.0 to 5.0. Examples of the alkenyl groups of the organopolysiloxane of component (A) include alkenyl groups having a carbon number of from 2 to 10 such as vinyl groups, allyl groups, butenyl groups, pentenyl groups, hexenyl groups, and heptenyl groups, with vinyl groups or hexenyl groups being particularly preferable. Examples of the bonding position of the alkenyl groups of component (A) include the molecular chain terminals and/or the molecular side chains. Note that component (A) may contain a single component or may be a mixture of two or more different components.

Examples of silicon-bonded organic groups other than alkenyl groups in the organopolysiloxane of component (A) include alkyl groups such as methyl groups, ethyl groups, propyl groups, butyl groups, pentyl groups, hexyl groups, and heptyl groups; aryl groups such as phenyl groups, tolyl groups, xylyl groups, and naphthyl groups; aralkyl groups such as benzyl groups and phenethyl groups; and halogenated alkyl groups such as chloromethyl groups, 3-chloropropyl groups, and 3,3,3-trifluoropropyl groups, with methyl groups and phenyl groups being particularly preferable.

In this invention, component (A) is different from component (B) and has a linear organopolysiloxane molecular structure. For example, component (A) is preferably a straight chain or partially branched straight chain and may partially include a cyclic three-dimensional network. Preferably, the main chain of the organopolysiloxane consists of repeating diorganosiloxane units (i.e., —SiO_{2/2} or D units) and is preferably a straight-chain or branched-chain diorganopolysiloxane capped at both molecular terminals with triorganosiloxy groups. Note that the siloxane units that provide a branched-chain organopolysiloxane are T units or Q units described below.

The properties of component (A) at room temperature may be those of an oily or raw rubber-like substance, with the viscosity of component (A) being no lower than 50 mPa·s and particularly preferably no lower than 100 mPa·s at 25° C. In particular, when the linear organopolysiloxane composition according to the present invention is a solvent type, at least a portion of component (A) is (A1) a raw rubber-like alkenyl group-containing organopolysiloxane having a viscosity of no less than 100,000 mPa·s at 25° C. or having a plasticity number (the thickness when a 1 kgf load applied for 3 minutes to a 4.2 g spherical sample at 25° C. was read up to 1/100 mm and this value was multiplied by 100) within a range of from 50 to 200, preferably 80-200, more preferably 100-200 as measured in accordance with the method as prescribed in JIS K6249.

Note that in order to prevent contact failure, etc., volatile or low molecular weight siloxane oligomers (such as octamethyltetracyclosiloxane (D4), decamethylpentacyclosiloxane (D5), etc.) in the organopolysiloxanes alkenyl group are preferably reduced or eliminated. The degree can be designed as desired, but must be less than 1% by mass of the total component (A), less than 0.1% by mass for each siloxane oligomer, and must be reduced to the vicinity of the detection limit as required.

Although the content of alkenyl groups in component (A1) is not particularly limited, the content of the vinyl (CH₂═CH) portion in the alkenyl groups in component (A1) (hereinafter, referred to as the “vinyl content”) can be preferably in the range of from 0.005 to 0.400 mass %, preferably in the range of from 0.005 to 0.300 mass %, and particularly preferably in the range of from 0.005 to 0.200 mass %.

In some embodiments according to the present invention, component (A) having a lower viscosity than that of component (A1) is also available as component (A) of the present invention. Specifically, an organopolysiloxane (A2) containing alkenyl groups having a viscosity of less than 100,000 mPa·s at 25° C. is available. Here, examples other than the viscosity of component (A2) are the same as component (A1).

In the present invention, 50 mass % or more of component (A) is preferably an alkenyl group-containing organopolysiloxane with a high degree of polymerization, which is component (A1), with 75 to 100 mass % thereof being particularly preferably component (A1). That is, when component (A1) (=an alkenyl group-containing organopolysiloxane with a higher degree of polymerization) and component (A2) (=an alkenyl group-containing organopolysiloxane with a lower degree of polymerization) are used in combination as component (A) of the present invention, the mass ratios of component (A1) to component (A2) range from 50:50 to 100:0, preferably 75:25 to 100:0, more preferably 75:25 to 90:10.

In this invention, the organopolysiloxane resin of component (B) is an adhesion imparting component imparting adhesive force to a substrate and simultaneously achieves a storage elastic modulus at low temperatures and a practical adhesive force range, using an organopolysiloxane resin mixture in a constant ratio to component (A). More specifically, component (B) is an organopolysiloxane resin having a small average molecular weight, wherein the content of hydroxyl groups or hydrolyzable groups is suppressed, and wherein a hydrolysis/polymerization reaction between components (B) tends not to occur, while the selective use of an organopolysiloxane resin having a small average molecular weights achieves a predetermined storage elastic modulus and practical adhesive force range in the pressure sensitive adhesive layer which is the cured product thereof.

Specifically, component (B) is an organopolysiloxane resin, wherein the total content of hydroxyl groups and hydrolyzable groups with respect to the number of all silicon atoms in the molecule is 9 mole % or less, 8 mass % or less, 6 mass % or less. Regarding component (B) according to the present invention, the sum of the content of hydroxyl groups and hydrolyzable groups in the molecule is within a range of 9 mole % or less with respect to all silicon atoms in the organopolysiloxane resin molecule and is preferably 7 mole % or less with respect to all silicon atoms in the molecule. Note that in component (B), the content of such hydroxyl groups and hydrolyzable groups can be expressed by converting all of these functional groups into hydroxyl groups. In this case, when the mass % is calculated assuming that all of the hydrolyzable groups other than the hydroxyl groups in the organopolysiloxane resin molecule are hydroxyl groups (OH), the sum of the content of the abovementioned hydroxyl groups and hydrolyzable groups can be expressed such that the content of these hydrolyzable groups which are converted into hydroxyl groups and hydroxyl groups in the organopolysiloxane resin molecule is 2.0 mass % or less, 1.6 mass % or less, 1.5 mass % or less, 1.2 mass % or less. The hydroxyl groups or hydrolysable groups are groups which are directly bonded to silicon atoms of T units or Q units, etc. among the siloxane units in the below-mentioned resin structure and obtained by hydrolyzing the silanes or silane derivatives. Consequently, the content of hydroxyl groups or hydrolyzable groups can be reduced by hydrolyzing the synthesized organopolysiloxane resin with a silylating agent such as trimethylsilane.

In component (B), when the amount of the hydroxyl groups or hydrolyzable groups exceeds the abovementioned upper limit, the condensation reaction between the organopolysiloxane resin molecules proceeds, facilitating the formation of an organopolysiloxane resin structure having a large molecular weight in the cured product. Such an organopolysiloxane resin having a high molecular weight tends to impair the curability of the overall composition, the curability of the composition at low temperatures may be insufficient, and the resulting pressure sensitive adhesive layer may not have sufficient storage elastic modulus for practical use.

In this invention, component (B) is an organopolysiloxane resin having a three dimensional structure. Examples thereof include a resin consisting of R₂SiO_{2/2} units (D units) and RSiO_{3/2} units (T units) (wherein, each R independently represents a monovalent organic group) and having a content of hydroxyl groups or hydrolyzable groups within the abovementioned range, a resin consisting of only T units and having a content of hydroxyl groups or hydrolyzable groups within the abovementioned range, and a resin consisting of R₃SiO_{1/2} units (M units) and SiO_{4/2} units (Q units) and having a content of hydroxyl groups or hydrolyzable groups within the abovementioned range. In particular, resin (also referred to as MQ resin) is preferably used which consists of R₃SiO_{1/2} units (M units) and SiO_{4/2} units (Q units), wherein the sum of the content of hydroxyl groups and hydrolyzable groups with respect to all silicon atoms in the molecule is 0 to 7 mole % (which is preferably within a range of 0.0 to 1.6 mass % when all of these functional groups are converted into hydroxyl groups).

The monovalent organic group of R is preferably a monovalent hydrocarbon group having a carbon number of from 1 to 10, with examples thereof including alkyl groups having a carbon number of from 1 to 10, alkenyl groups having a carbon number of from 2 to 10, aryl groups having a carbon number of from 6 to 10, cycloalkyl groups having a carbon number of from 6 to 10, benzyl groups, phenylethyl groups, and phenylpropyl groups. In particular, 90 mole % or more of R is preferably alkyl groups having 1 to 6 carbon atoms or phenyl groups, while 95 to 100 mole % of R is particularly preferably methyl groups or phenyl groups.

Preferably, component (B) is (B1) an organopolysiloxane resin or mixture thereof which consists essentially of R₃SiO_{1/2} units and SiO_{4/2} units, where R is a monovalent organic group and 90 mole % or more of R is an alkyl group having 1 to 6 carbon atoms or a phenyl group. When component (B) is a resin consisting of R₃SiO_{1/2} units (M units) and SiO_{4/2} units (Q units), the molar ratio of M units to Q units is preferably from 0.5 to 2.0. This is because when the molar ratio is less than 0.5, the adhesive force to the substrate may be diminished, whereas when the molar ratio is greater than 2.0, the cohesive strength of the material constituting the adhesive layer decreases. Moreover, D units and T units may also be included in component (B) to such an extent that does not impair the characteristics of the present invention. Further, in order to prevent contact failure, etc., low molecular weight siloxane oligomer in these organopolysiloxane resins may be reduced or eliminated.

In the present invention, the weight average molecular weight (Mw) of said organopoly siloxane resin serving as component (B) is not limited, and at least one organopolysiloxane resin having specific Mw or a mixture of two or more of organopolysiloxane resin having different Mw can be used as component (B). From practical viewpoint, Mw of component (B) measured in terms of standard polystyrene by gel permeation chromatography (GPC) ranges from 500 to 20,000 (g/mol), preferably from 1,000 to 17,500 (g/mol), most preferably from 2,000 to 16,500 (g/mol).

### Mass Ratio of Component (B) to Component (A)

The pressure sensitive adhesive layer-forming organopolysiloxane composition according to the present invention characteristically has a mass ratio of component (B) (which is an organopolysiloxane resin) to component (A) (which is a chain reactive siloxane component) within the specific range. In combination with component (D) as anchorage additive, the mass ratio of component (B) to component (A) is within a range of 0.5 to 3.5, 0.5 to 2.5, 0.5 to 1.5, 0.5 to 0.75, 0.75 to 3.5, 0.75 to 3.0, 0.75 to 2.5, 0.75 to 1.5, 1.5 to 3.5, 1.5 to 2.5 or 2.5 to 3.5. Specifically, if (A′) the chain organopolysiloxane which does not contain a carbon-carbon double bond-containing reactive group in the molecule is optional, the mass ratio of component (B) to component (A) is within a range of 0.9 to 1.8, 0.9 to 1.6, 0.9 to 1.4, 0.9 to 1.2, 1.2 to 1.8, 1.2 to 1.6, 1.2 to 1.4, 1.4 to 1.8, 1.4 to 1.6 or 1.6 to 1.8. In contrast, if this composition contains component (A′) and the mass ratio of component (A) to component (A′) is within a range of 95:5 to 60:40, 90:10 to 60:40, 80:20 to 60:40, 70:30 to 60:40, 90:10 to 70:30 or 80:20 to 70:30, the mass ratio of component (B) to component (A) is within a range of 0.9 to 2.4, 0.9 to 2.0, 0.9 to 1.6 or 0.9 to 1.2. In other words, if components (A) and (A′) are used at above mass ratio, even if the mass ratio of component (B) to component (A) is within a range of more than 1.8 to 2.4, the technical effects of the present invention can also be achieved.

If component (A′) is not an essential component in the composition according to the present invention, in order to achieve the desired adhesive force and storage elastic modulus, the mass ratio of component (B) to the sum of components (A) and (A′) is within a range of 0.9 to 1.8, and may be within a range of 1.0 to 1.77, 1.2 to 1.6 or 1.4 to 1.5. Note that in the case of the mass ratio of component (B) to component (A), regarding the further use of component (A′), it is one of preferred embodiments of the present invention without impairing the technical effects of the present invention.

In contrast, if component (A′) is an essential component in the composition according to the present invention and the mass ratio of component (A) to component (A′) is within a range of 95:5 to 40:60, the mass ratio of component (B) to the sum of components (A) and (A′) is within a range of 0.9 to 2.4, 0.9 to 2.0, 0.9 to 1.6 or 0.9 to 1.2, and may be within a range of 0.9 to 2.3 or within a range of 1.0 to 2.3.

In this invention, component (C) is an organohydrogenpolysiloxane having two or more Si—H bonds per molecule and is a crosslinking agent in the organopolysiloxane composition of the present invention. The molecular structure of component (C) is not particularly limited, with examples thereof including a straight chain, a partially branched straight chain, a branched chain, a cyclic, or an organopolysiloxane resin structure, and with a straight chain, a partially branched straight chain, or an organopolysiloxane resin structure being preferable. The bonding position of silicon-bonded hydrogen atoms is not particularly limited, with examples thereof including molecular terminals, side chains, or both molecular terminals and side chains. The content of the silicon-bonded hydrogen atoms is from 0.1 to 2.0 mass %, preferably from 0.5 to 1.7 mass % and more preferably from 0.8 to 1.5 mass %.

Exemplary silicon-bonded organic groups in component (C) include: alkyl groups having 1 to 8 carbon atoms such as methyl groups, ethyl groups, propyl groups, butyl groups, and octyl groups; aryl groups such as phenyl groups and tolyl groups; aralkyl groups such as benzyl groups and phenethyl groups; and halogenated alkyl groups such as 3-chloropropyl groups and 3,3,3-trifluoropropyl groups, wherein 50% moles or more of the total number thereof are preferably alkyl groups having 1 to 8 carbon atoms or phenyl groups. From the perspective of ease of manufacture and compatibility with the preferred components (A) and (B) described above, the other organic groups are preferably methyl groups or phenyl groups.

When component (C) of the present invention is an organohydrogenpolysiloxane, which is an organopolysiloxane resin, examples thereof include organopolysiloxane copolymers consisting of siloxane units represented by the general formula: R′₃SiO_{1/2}, siloxane units represented by the general formula R′₂HSiO_{1/2}, and siloxane units represented by the formula: SiO_{4/2}; organopolysiloxane copolymers consisting of siloxane units represented by the general formula: R′₂HSiO_{1/2} and siloxane units represented by the formula: SiO_{4/2}; organopolysiloxane copolymers consisting of siloxane units represented by the general formula: R′₂HSiO_{1/2} and siloxane units represented by the formula: R′SiO_{3/2}; organopolysiloxane copolymers consisting of siloxane units represented by the general formula: R′HSiO_{2/2}, siloxane units represented by the general formula: R′SiO_{3/2}, or siloxane units represented by the formula: HSiO_{3/2}; and mixtures of two or more types of these organopolysiloxanes. Note that R′ in the formulas is an alkyl group having a carbon number of from 1 to 8, an aryl group, an aralkyl group, or a halogenated alkyl group, with examples thereof being the same as those described above.

Specific examples of component (C) include tris(dimethylhydrogensiloxy)methylsilane, tetra(dimethylhydrogensiloxy)silane, methylhydrogenpolysiloxanes capped at both terminals with trimethylsiloxy groups, dimethylsiloxane/methylhydrogensiloxane copolymers capped at both terminals with trimethylsiloxy groups, dimethylsiloxane/methylhydrogensiloxane copolymers capped at both terminals with dimethylhydrogensiloxy groups, cyclic methylhydrogen oligosiloxanes, cyclic methylhydrogensiloxane/dimethylsiloxane copolymers, methylhydrogensiloxane/diphenylsiloxane copolymers capped at both molecular terminals with trimethylsiloxy groups, methylhydrogensiloxane/diphenylsiloxane/dimethylsiloxane copolymers capped at both molecular terminals with trimethylsiloxy groups, hydrolytic condensates of trimethylsilanes, copolymers consisting of (CH₃)₂HSiO_{1/2} units and SiO_{4/2} units, copolymers consisting of (CH₃)₂HSiO_{1/2} units, SiO_{4/2} units, and (C₆H₅)SiO_{3/2} units, copolymers consisting of (CH₃)₂HSiO_{1/2} units and CH₃SiO_{3/2} units, and mixtures of two or more types thereof.

In the case of a straight-chain structure, in particular, a methylhydrogenpolysiloxane represented by the molecular structural formula: R^{T}Me₂SiO(Me₂SiO)_{q}(HMeSiO)ᵣSiMe₂R^{T} (wherein, Me is a methyl group, R^{T} is a methyl group or a hydrogen atom, and q and r are numbers satisfying 0.35 r/(q+r)≤1 and 5≤(q+r)≤200) is preferable. Note that component (C) may use two or more different types in combination.

Similarly, the following organosiloxanes may be given as examples. Note that in the formulas, Me and Ph respectively represent a methyl group and a phenyl group, m is an integer from 1 to 100, n is an integer from 1 to 50, and b, c, d, and e are each positive numbers, where the sum of b, c, d, and e in one molecule is 1.

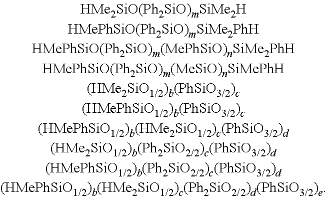

### SiH/Vi Ratio

The composition according to the present invention is hydrosilylation reaction curable and the usage amount of component (C) is not particularly limited as long as the composition can sufficiently cure via a hydrosilylation reaction. However, the amount of silicon atom-bonded hydrogen atom (SiH) groups in component (C) with respect to the sum of the amount (substance amount) of alkenyl groups in component (A) and the amount (substance amount) of alkenyl groups in component (B) in the composition, that is, the molar ratio, is preferably within a range of 1.0 to 100, and may be within a range of 5.0 to 60, within a range of 10 to 50, or within a range of 20 to 50.

In contrast, in order to improve adhesion to a substrate of glass, etc., the number of SiH groups per molecule can be designed to be 3 or more and 5 or more, is preferably more than 10, and more preferably 20 or more. For example, the substance amount of silicon atom-bonded hydrogen atoms (SiH) groups in component (C) with respect to the sum of the amount (substance amount) of alkenyl groups in component (A) and the amount (substance amount) of alkenyl groups in component (B) in the composition can be designed so as to be in a range of 10 to 60 and a range of 10 to 50. When the amount of the SiH groups falls below the abovementioned lower limit, the technical effect of improving adhesion to the substrate may not be achieved. In contrast, when the amount of the SiH groups exceeds the abovementioned upper limit, the amount of unreacted residual curing agent becomes large, which may have adverse effects on curing physical properties such as the brittleness of the cured product or may cause problems such as gas generation. However, a pressure sensitive adhesive layer can be formed which is sufficient for practical use even when the SiH/Vi ratio of the composition is outside the abovementioned range.

### [Hydrosilylation Reaction Catalyst]: Component (D)

The organopolysiloxane composition of the present invention contains a hydrosilylation reaction catalyst. Examples of hydrosilylation reaction catalysts include platinum-based catalysts, rhodium-based catalysts, and palladium-based catalysts, with platinum-based catalysts preferable in that they markedly accelerate the curing of the present composition. Examples of this platinum based catalyst include platinum fine powder, chloroplatinic acid, an alcohol solution of chloroplatinic acid, a platinum-alkenyl siloxane complex, a platinum-olefin complex, and a platinum-carbonyl complex, with a platinum-alkenyl siloxane complex particularly preferable. Examples of this alkenyl siloxane include 1,3-divinyl-1,1,3,3-tetramethyldisiloxane, 1,3,5,7-tetramethyl-1,3,5,7-tetravinylcyclotetrasiloxane, alkenyl siloxanes in which some of the methyl groups of these alkenyl siloxanes are substituted with groups selected from the group consisting of nitriles, amides, dioxolanes, sulfolanes, ethyl groups, phenyl groups, or the like, and alkenyl siloxanes in which the vinyl groups of these alkenyl siloxanes are substituted with allyl groups, hexenyl groups, or the like. In particular, 1,3-divinyl-1,1,3,3-tetramethyldisiloxane is preferable because the platinum-alkenyl siloxane complex has good stability. As the catalyst for promoting the hydrosilylation reaction, a non-platinum based metal catalyst such as iron, ruthenium, iron/cobalt, or the like may be used.

While the content of the hydrosilylation reaction catalyst is not particularly limited thereto in the present invention, the amount of the platinum based metal with respect to the total amount of solids in the composition is within a range of 0.1 to 200 ppm, and may be within a range of 0.1 to 150 ppm, within a range of 0.1 to 100 ppm, or within a range of 0.1 to 60 ppm. Here, the platinum-based metal is a metal element of group VIII consisting of platinum, rhodium, palladium, ruthenium, and iridium; however, in practical use, the content of the platinum metal excluding the ligands of the hydrosilylation catalyst is preferably within the range described above. Note that the solid content is a component that forms the cured layer (primarily a main agent, an adhesion-imparting component, a crosslinking agent, a catalyst, and other non-volatile components) when the organopolysiloxane composition of the present invention is subjected to a curing reaction and does not include volatile components such as solvents that volatilize at the time of heat curing.

When the content of the platinum based metal in the organopolysiloxane composition according to the present invention is 60 ppm or less, 50 ppm or less, 40 ppm or less, 30 ppm or less, 25 ppm or less, or 20 ppm or less, this may suppress discoloration or coloration of the transparent pressure sensitive adhesive layer, in particular, after curing or when heated or exposed to high energy rays such as UV rays. Meanwhile, from the perspective of the curability of the organopolysiloxane composition, the content of the platinum-based metal is no lower than 0.1 ppm, as when the content is lower than this lower limit, this may cause curing defects.

In this Invention, component (E) is a curing retarder (=curing inhibitor) and is compounded in order to suppress crosslinking reactions between the alkenyl groups in the composition and the SiH groups in component (C) so as to extend the usable life at ordinary temperatures and enhance the storage stability. Accordingly, in practical use, the component (E) may be added to the pressure sensitive adhesive layer-forming organopoly siloxane composition according to the present invention.

Specific examples of component (E) include acetylenic compounds, eneyne compounds, organic nitrogen compounds, organic phosphorus compounds, and oxime compounds. Specific examples include: alkyne alcohols such as 3-methyl-1-butyne-3-ol, 3,5-dimethyl-1-hexyne-3-ol, 3-methyl-1-pentyne-3-ol, 1-ethynyl-1-cyclohexanol, phenyl butanol, and the like; eneyne compounds such as 3-methyl-3-pentene-1-yne, 3,5-dimethyl-1-hexyne-3-yne, and the like; methylalkenylcyclosiloxanes such as 2-ethynyl-4-methyl-2-pentene, 1,3,5,7-tetramethyl-1,3,5,7-tetravinylcyclotetrasiloxane, 1,3,5,7-tetramethyl-1,3,5,7-tetrahexenylcyclotetrasiloxane, and the like, as well as benzotriazoles.

From the perspective of the curing behavior of the composition, the pressure sensitive adhesive layer-forming organopoly siloxane composition of the present invention is preferably curable at 80 to 200° C. with an increase in viscosity within 1.5-fold after 8 hours at room temperature following the preparation of the composition. The suppression of thickening is important from the perspective of handleability, pot life, and characteristics after curing and contains a large excess of component (C), wherein, even if the content of the platinum-based metal is optionally low, the curability can be ensured by curing at high temperature of at least a certain temperature (80 to 200° C.). Note that such a composition can be realized by selecting a suitable combination and compounded amounts of each of the components described above, the hydrosilylation catalyst, and component (E).

In addition to the preferred components (A) and (B) described above, the organopolysiloxane composition of the present invention may also contain an organic solvent as a solvent. The type and blending amount of the organic solvent can be adjusted taking the coating workability, etc. into consideration. Exemplary organic solvents include: aromatic hydrocarbon-based solvents such as toluene, xylene, and benzene; aliphatic hydrocarbon-based solvents such as heptane, hexane, octane, and isoparaffin; ester-based solvents such as ethyl acetate and isobutyl acetate; ether-based solvents such as diisopropyl ether and 1,4-dioxane; chlorinated aliphatic hydrocarbon-based solvents such as trichloroethylene, perchloroethylene, and methylene chloride; and solvent volatile oils; with two or more types capable of being combined in accordance with the wettability of the sheet-like substrate or the like. The compounded amount of the organic solvent is preferably an amount such that a mixture of components (A) to (C) can be uniformly applied to a sheet-like substrate surface. For example, the compounded amount may be from 5 to 3000 parts by mass per total amount of 100 parts by mass of components (A), (B) and (C).

The organopolysiloxane composition of the present invention may optionally contain components other than the components described above to such an extent that does not impair the technical effects of the present invention. For example, the composition may contain: an adhesion promoter, a non-reactive organopolysiloxane such as a polydimethylsiloxane or a polydimethyldiphenylsiloxane; an antioxidant such as a phenol-type, a quinone-type, an amine-type, a phosphorus-type, a phosphite-type, a sulfur-type, or a thioether-type antioxidant; a flame retardant such as a phosphate ester-type, a halogen-type, a phosphorus-type, or an antimony-type flame retardant; and one or more types of antistatic agents consisting of a cationic surfactant, an anionic surfactant, a non-ionic surfactant, or the like. Note that, in addition to these components, pigments, dyes, inorganic microparticles (e.g., reinforcing fillers, dielectric fillers, conductive fillers, thermally conductive fillers), etc. can be optionally blended.

### (A′) Linear/Chain Organopolysiloxane which does not Contain a Carbon-Carbon Double Bond-Containing Reactive Group in the Molecule

The organopolysiloxane composition according to the present invention can comprises a non-reactive organopolysiloxane such as a polydimethylsiloxane or polydimethyldiphenylsiloxane that does not contain a carbon-carbon double bond-containing reactive group such as an alkenyl group, acryl group, or methacryl group. As a result, it may be possible to improve the loss coefficient (tan δ), storage elastic modulus (G′), loss modulus (G″), and adhesion of the pressure sensitive adhesive layer. For example, the loss coefficient of the pressure sensitive adhesive layer can be increased using a polydimethyl siloxane having a hydroxyl group terminal, or a polydimethylsiloxane or polydimethyldiphenylsiloxane having a trimethylsiloxy terminal, with such compositions included within the scope of the present invention.

Specifically, if the mass ratio of component (B) to the sum of components (A) and (A′) is within a range of 0.9 to 2.4, the mass ratio of component (A) to component (A′) must be within a range of 95:5 to 40:60, with the mass ratio of component (A) to component (A′) preferably being within a range of 90:10 to 40:60.

### Optional Tetraalkoxysilane or a Prepolymer of the Tetraalkoxysilane as Anchorage Additive

To increase or improve adhesive force, in this invention, at least one tetraalkoxysilane or a prepolymer of the tetraalkoxysilane as an anchorage additive of the silicone-based PSA composition can be formulated. Although rheological/viscoelastic properties in cured silicone PSA layer is generally determined by its cross-linking polymer structure (including polymer chain length), resinous structures (including silicone-resin units and Mw) and molar ratio therein resulting in trade-off relationship between lower Tg or modulus and higher adhesion force, only adhesion force can be increased without affecting lower Tg or modulus properties in cured silicone PSA layer by using tetraalkoxysilane or a prepolymer of the tetraalkoxysilane as anchorage additive.

In preferred embodiment of this invention, the adhesive force of a pressure sensitive adhesive layer having a thickness of 50 μm obtained by curing the composition, as measured at a tensile speed of 300 mm/min using a 180° peeling test method according to JIS Z 0237 for glass substrate etc. is more than 20% greater than, preferably 30% to 80% greater than that for the pressure sensitive adhesive layer obtained from the same composition but lacking tetraalkoxysilane as anchorage additive.

To achieve said technical benefit, said tetraalkoxysilane is exemplified by tetramethoxysilane, tetraethoxysilane or mixture thereof. Using other silanes like glycidoxypropyltrimethoxysilane or vinyltrimethoxysilane in replacement of said tetraalkoxysilane may not improve or enhance the adhesive force without affecting its rheological/viscoelastic properties for the silicone-based pressure sensitive adhesive layer. Furthermore, to achieve sufficient improvement in the adhesive force, the amount of tetraalkoxysilane based on total mass of components (A) to (C) is within a range of 0.1 to 9.0 mass %, preferably within a range of 0.2 to 7.0 mass %, more preferably within a range of 0.5 to 5.0 mass % assuming the mass ratio of component (B) to component (A) is within a range of 0.5 to 3.5. When the amount of the tetraalkoxysilane falls below the abovementioned lower limit, the technical effect of improving adhesion to the substrate may not be sufficiently achieved. In contrast, when the amount of tetraalkoxysilane exceeds the abovementioned upper limit, excess amount of tetraalkoxysilane or a prepolymer of the tetraalkoxysilane may have adverse effects on curing physical properties.

The method of preparing the silicone-based PSA-forming composition is not particularly limited and is performed by homogeneously mixing the respective components. A solvent may be added as necessary and the composition may be prepared by mixing at a temperature of from 0 to 200° C. using a known stirrer or kneader.

### Forming Adhesive Layer Using Said Silicone-Based PSA-Forming Composition

Aforementioned silicone-based PSA-forming composition forms a cured adhesive layer when applied to a substrate and forms a cured product by heating under temperature conditions of from 80 to 200° C., preferably under temperature conditions of from 90 to 190° C. Examples of application methods include gravure coating, offset coating, offset gravure, roll coating, reverse roll coating, air knife coating, curtain coating, and comma coating.

The cured adhesive layer from said silicone-based PSA-forming composition is arranged between the functional layers to bond/assemble the layers in the electronic article of this invention.

### Properties Relating to Transparency, Color Tone, or Coloration and Discoloration of the Pressure Sensitive Adhesive Layer

The interlayer adhesive layer, which is preferred to be aforementioned silicone-based PSA layer, applied to the present invention can be transparent or untransparent assembly layer. That is to say, the transparent property is optional property in the interlayer adhesive layer of this invention, and it depends on where said interlayer adhesive layer is located in the electronic device. When said interlayer adhesive layer is arranged above panel unit and close to its cover-glass or other transparent-cover unit, it should be “transparent” interlayer adhesive layer. On the other hand, when said interlayer adhesive layer is located at the bottom of panel unit, there is no requirement of transparency property in the interlayer adhesive layer. Notwithstanding, the interlayer adhesive layer of this invention may be substantially transparent, translucent, or opaque, such that the transparency thereof can be designed in accordance with the application of said interlayer adhesive layer. For example, as an interlayer pressure sensitive adhesive layer applied for a display device of present invention, a film-like cured product with a thickness of from 1 to 1000 μm obtained by curing said silicone-based PSA-forming composition is preferably visually transparent and preferably does not contain a coloring additive such as carbon black. Note that when it is visually transparent, or more objectively, when the value for air is 100%, the transmittance of light at a wavelength of 450 nm of the pressure sensitive adhesive layer for a display device formed from a cured layer having a thickness of 100 μm is 80% or higher and suitably 90% or higher and may be designed to be 95% or higher. In contrast, in the adhesion, etc. of an electrical or electronic part which does not require light transmittance, a semi-transparent to opaque pressure sensitive adhesive layer may be used, with a filler component or additive which impairs colorability or light transmittance capable of being used depending on the required characteristics other than light transmittance.

Said interlayer adhesive layer can be designed such that the cured product is not colored, in addition to the abovementioned transparency, by optionally reducing the content of the platinum based metal in the cured layer. Specifically, the b* value, which is measured with the L*a*b* color system as prescribed in JIS Z 8729, immediately after curing a cured layer having a thickness of 100 μm obtained by curing the organopolysiloxane composition of the present invention, can be designed so as to be no greater than 0.15 and no greater than 0.10. Having such b* values means that the cured layer is substantially transparent and not yellow colored.

Even when the cured layer of the present invention is exposed to high temperatures or high-energy beams such as UV rays for an extended period of time, it can be designed such that the color tone thereof does not significantly change and the problem of yellowing, in particular, does not occur. Specifically, even if any of the following evaluations are made, the change (Ab*) in the b* value measured with the L*a*b* color system as prescribed in JIS Z 8729 immediately after evaluation, for a cured layer having a thickness of 100 μm obtained by curing the organopolysiloxane composition of the present invention, can be designed so as to be no greater than 0.20 and preferably no greater than 0.15. Note that Ab* is an absolute value of the numerical change.
(1) Thermal aging evaluation: The cured layer is aged for 300 hours at 105° C.
(2) High-energy beam irradiation: A sample of the cured layer is irradiated for 75 hours at room temperature with UV light using a mercury lamp (for example, Optical Module X or the like manufactured by Ushio Electric Co., Ltd.) having an intensity of 12 mW/cm² at 365 nm and an intensity of 3.5 mW/cm² at 254 nm.

### Use as an Interlayer Pressure Sensitive Adhesive Layer Applied for the Electronic Article

In order to improve adhesion with the adherend, surface treatment such as primer treatment, corona treatment, etching treatment, or plasma treatment may be performed on the surface of the adhesive layer or the substrate. However, because the adhesive layer obtained by curing said silicone-based PSA-forming composition has excellent adhesion to a substrate of a display device, etc. as described above, these steps may be added, as required, to further improve the adhesion with the adherend, with a higher production efficiency capable of being achieved by eliminating these steps.

Said silicone-based PSA-forming composition can be cured by applying the composition to a release liner, heating under the temperature conditions described above, then, after the release liner is peeled off and the composition is attached to a film-like substrate, a tape-like substrate, or a sheet-like substrate (called as a “film-like substrate” hereinafter) or applied to a film-like substrate, curing by heating at the temperature conditions described above so as to form a pressure sensitive adhesive layer on the surface of the substrate. A laminate provided with a cured layer—in particular, a film-like pressure sensitive adhesive layer-obtained by curing the silicone-based PSA-forming composition on these film-like substrates, is used to bond or assemble functional layers in the construction of electronic articles and use of a laminated touch screen or flat panel display. As described above, the adhesive layer is applied as a single-coating layer having both assembly/bonding layer function and damping/shock-absorption layer function, the manufacturing process for the electronic article of this invention can be a simplified process not requiring multi-step lamination/coating process to build its interlayer damping or shock-absorption layer.

The coating amount of the silicone-based PSA-forming composition can be designed at a desired thickness in accordance with the application such as a display device, as one example, the thickness of the pressure sensitive adhesive layer after curing may be from 1 to 1000 μm, from 5 to 900 μm, or from 10 to 800 μm; however, there is no limitation thereto.

The pressure sensitive adhesive layer according to the present invention may be a single layer or a multilayer structure obtained by laminating two or more pressure sensitive adhesive layers, in accordance with the required characteristics. Multiple pressure sensitive adhesive layer may be formed by bonding the pressure sensitive adhesive films (which are formed film by film) thereto, or the step of applying and curing the silicone-based PSA-forming composition may be carried out multiple times on a film substrate (including a release layer), etc.

The pressure sensitive adhesive layer may serve as other functional layers selected from a dielectric layer, conductive layer, heat dissipation layer, insulating layer, reinforcing layer, etc., in addition to adhering or sticking functions between members and damping/shock-absorption layer function.

When the adhesive layer obtained by curing said silicone-based PSA-forming composition is a pressure sensitive adhesive layer, in particular, a pressure sensitive adhesive layer, the cured layer is preferably treated as a laminate film that is peelably adhered to a film substrate provided with a release layer having a release-coating capability. The release layer may also be referred to as a release liner, a separator, a release layer, or a release coating layer, and may preferably be a release layer having a release coating ability such as a silicone-based release agent, a fluorine-based release agent, an alkyd-based release agent, or a fluorosilicone-based release agent, or the release layer may be formed as a substrate itself which is not prone to adhering to the resin sheet for a pressure sensitive adhesive layer of the present invention by forming physically fine irregularities in the surface of the substrate. In particular, in the laminated body according to the present invention, a release layer obtained by curing a fluorosilicone release agent is preferably used as the release layer.

The interlayer adhesive layer, which is preferred to be aforementioned silicone-based PSA layer, has aforementioned viscoelastic property in its tan δ curve measurement and adhesive strength as described above, making it useful as a member of various types of electronic equipment or electrical devices as elastic adhesive members. In particular, it is useful as an electronic material, a member for a display device, or a member for a transducer (including sensors, speakers, actuators, and generators), with a suitable application for the cured product being a member for an electronic part or a display device. The cured product according to the present invention may be transparent or opaque, wherein, in particular, a film-shaped cured product, particularly a substantially transparent pressure sensitive adhesive film, is suitable as a member for a display panel or a display, and is particularly useful in so-called touch panel applications in which a device, particularly an electronic device, can be operated by touching a screen with a fingertip or the like. Moreover, the opaque elastic adhesive layer is not required to have transparency, making it particularly useful for applications of film-like or sheet-like members used in sensors, speakers, actuators, etc. which require constant elasticity or flexibility in the adhesive layer itself.

Furthermore, the interlayer adhesive layer according to the present invention is capable of achieving a pressure sensitive adhesive characteristic equivalent to conventional silicone pressure sensitive adhesive layers and can improve adhesion to the substrate of a display device etc. and also provides impact resistance to the electronic article as a damping/shock-absorption layer in the electronic articles of this invention.

### EXAMPLES

These examples are intended to illustrate the invention to one skilled in the art and are not to be interpreted as limiting the scope of the invention set forth in the claims. The materials in Table 1 were used in these examples. Note that the viscosity and plasticity number of each component in the present invention was measured at room temperature using the following method.

### (Viscosity)

The viscosity (mPa·s) is a value measured using a rotary viscometer conforming to JIS K7117-1, while the kinematic viscosity (mm²/s) is a value measured with an Ubbelohde viscometer conforming to JIS Z8803).

### (Plasticity Number)

The plasticity number was expressed as a value measured in accordance with the method prescribed in JIS K 6249 (the thickness when a 1 kgf load was applied for 3 minutes to a 4.2 g spherical sample at 25° C. was read up to 1/100 mm, and this value was multiplied by 100).

TABLE 1
Components of the silicone-based PSA-forming composition

| Components | Characteristics |
|---|---|
| (A-1) | Vinyl-functional polydimethylsiloxane gum, plasticity number 152, vinyl content of 0.013 wt % |
| (A-2) | Vinyl-functional polydimethylsiloxane gum, plasticity number 156, vinyl content of 0.012 wt % |
| (A′) | Non-functional (trimethylsilyl-capped) polydimethylsiloxane gum, plasticity number of 170 |
| (B-1) | Me-Capped MQ in xylene; Mw = 14800 g/mol; Mn = 4700 g/mol, non-volatile content of 78 |
| | mass % |
| (B-2) | Me-capped MQ in xylene; Mw = 10500 g/mol; Mn = 4100 g/mol, non-volatile content of 66 |
| | mass % |
| (B-3) | Me-Capped MQ in xylene; Mw = 5400 g/mol; Mn = 2900 g/mol, non-volatile content of 70 mass % |
| (C-1) | Poly (dimetylsiloxane-co-methyl hydrogen) siloxane, trimethylsilyl-end-capped, with H content |
| | of 0.76 mass %; M-(DD(H))10-M |
| (C-2) | Poly (methyl hydrogen) siloxane, trimethylsilyl-end-capped, with H content 1.6 mass %; |
| | Homopolymer MD(H) nM |
| (E-1) | 1-ethyny1-1-cyclohexanol |
| (E-2) | bismaleate intermediate |
| (D) | Platinum catalyst containing 0.52 mass % Pt metal |

### Preparation of Curable Organopolysiloxane Composition

The curable organopolysiloxane compositions described in each of the examples and comparative examples were prepared using the components shown in Table 1. Also, formulations of working examples and comparative examples are summarized in Table 2.

### Measurement of the Molecular Weight of the Organopolysiloxane Component

Using gel permeation chromatography (GPC) available from Waters, tetrahydrofuran (THF) was used as a solvent and the weight average molecular weight (Mw) and number average molecular weight (Mn) of organopolysiloxane components such as organopolysiloxane resin were determined relative to standard polystyrenes.

### Viscoelasticity: Dynamic Mechanical Analysis: Tan δ

Each composition was applied to a release liner coated with a fluorosilicone release coating, with the thickness after curing of approximately 120 μm, followed by curing at 70° C. for 10 minutes and 150° C. for 10 minutes. Five or more of the pressure sensitive adhesive films were laminated to obtain a film sample having a thickness of 500 μm-1200 μm, both surface of which were sandwiched between release liners. The film was cut into a round shape of 8 mm in diameter and was subjected to a dynamic mechanical analysis using a parallel plate measuring system by an TA model DHR-2 rheometer with a mechanical chiller system. The measurement conditions were within a range of −70° C. to 200° C. at a frequency of 1 Hz and a temperature ramp of 3° C./minute, to provide storage elastic modulus G′, loss modulus G″, and tan δ, from which the tan δ peak temperature (Tg), tan δ value at the peak, and the temperature range where the tan δ value exceeds 0.5 were recorded.

### Example 1

21.0 parts by weight of the vinyl functional polydimethylsiloxane gum A-1, 3.0 parts by weight of the vinyl functional polydimethylsiloxane gum A-2, 53.5 parts by weight of the MQ silicone resin B-3, 47.0 parts by weight of toluene, 0.44 parts by weight of the dimethyl siloxane/methylhydrogen siloxane copolymer capped at both terminals with trimethylsiloxy groups C-1, 0.05 parts by weight of the methylhydrogen siloxane polymer capped at both terminals with trimethylsiloxy groups C-2, and 0.12 parts by weight of the curing inhibitor E-1 were sufficiently mixed at room temperature, after which 0.97 parts by weight of the platinum based hydrosilylation reaction catalyst D was added to the mixture and was mixed well to form a curable organopolysiloxane composition. The molar ratio of SiH groups in components C-1 and C-2 to the amount of alkenyl groups in components A-1 and A-2 (SiH/Vi ratio) was 36.2, while the content of the platinum metal to the solid content was 80.0 ppm. The composition was cured via the abovementioned method, after which the viscoelasticity was measured via the abovementioned method, with the evaluation results indicated in Table 3.

### Example 2

21.0 parts by weight of the vinyl functional polydimethylsiloxane gum A-1, 53.5 parts by weight of the MQ silicone resin B-3, 40.0 parts by weight of toluene, 0.44 parts by weight of the dimethyl siloxane/methylhydrogen siloxane copolymer capped at both terminals with trimethylsiloxy groups C-1, and 0.10 parts by weight of the curing inhibitor E-1 were sufficiently mixed at room temperature, after which 0.92 parts by weight of the platinum based hydrosilylation reaction catalyst D was added to the mixture and was mixed well to form a curable organopolysiloxane composition. The molar ratio of SiH groups in component C-1 to the amount of alkenyl groups in component A-1 (SiH/Vi ratio) was 33.1, while the content of the platinum metal to the solid content was 80.1 ppm.

The composition was cured via the abovementioned method, after which the viscoelasticity was measured via the abovementioned method, with the evaluation results indicated in Table 3.

### Example 3

21.0 parts by weight of the vinyl functional polydimethylsiloxane gum A-1, 71.5 parts by weight of the MQ silicone resin B-3, 45.4 parts by weight of toluene, 0.44 parts by weight of the dimethyl siloxane/methylhydrogen siloxane copolymer capped at both terminals with trimethylsiloxy groups C-1, and 0.10 parts by weight of the curing inhibitor E-1 were sufficiently mixed at room temperature, after which 1.12 parts by weight of the platinum based hydrosilylation reaction catalyst D was added to the mixture and was mixed well to form a curable organopolysiloxane composition. The molar ratio of SiH groups in component C-1 to the amount of alkenyl groups in component A-1 (SiH/Vi ratio) was 33.1, while the content of the platinum metal to the solid content was 79.9 ppm.

The composition was cured via the abovementioned method, after which the viscoelasticity was measured via the abovementioned method, with the evaluation results indicated in Table 3.

### Example 4

25.0 parts by weight of the vinyl functional polydimethylsiloxane gum A-2, 45.7 parts by weight of the MQ silicone resin B-2, 2.4 parts by weight of the MQ silicone resin B-3, 49.1 parts by weight of toluene, 0.28 parts by weight of the methylhydrogen siloxane polymer capped at both terminals with trimethylsiloxy groups C-2, 0.01 parts by weight of the curing inhibitor E-1, and 0.21 parts by weight of the curing inhibitor E-2 were sufficiently mixed at room temperature, after which 0.91 parts by weight of the platinum based hydrosilylation reaction catalyst D was added to the mixture and was mixed well to form a curable organopolysiloxane composition. The molar ratio of SiH groups in component C-2 to the amount of alkenyl groups in component A-2 (SiH/Vi ratio) was 40.2, while the content of the platinum metal to the solid content was 81.7 ppm.

The composition was cured via the abovementioned method, after which the viscoelasticity was measured via the abovementioned method, with the evaluation results indicated in Table 3.

### Example 5

27.4 parts by weight of the vinyl functional polydimethylsiloxane gum A-2, 45.7 parts by weight of the MQ silicone resin B-2, 2.4 parts by weight of the MQ silicone resin B-3, 54.7 parts by weight of toluene, 0.33 parts by weight of the methylhydrogen siloxane polymer capped at both terminals with trimethylsiloxy groups C-2, 0.02 parts by weight of the curing inhibitor E-1, and 0.21 parts by weight of the curing inhibitor E-2 were sufficiently mixed at room temperature, after which 0.95 parts by weight of the platinum based hydrosilylation reaction catalyst D was added to the mixture and was mixed well to form a curable organopolysiloxane composition. The molar ratio of SiH groups in component C-2 to the amount of alkenyl groups in component A-2 (SiH/Vi ratio) was 43.3, while the content of the platinum metal to the solid content was 81.5 ppm.

The composition was cured via the abovementioned method, after which the viscoelasticity was measured via the abovementioned method, with the evaluation results indicated in Table 3.

### Example 6

16.3 parts by weight of the vinyl functional polydimethylsiloxane gum A-1, 7.0 parts by weight of the non-functional (trimethylsilyl-capped) polydimethylsiloxane gum A′, 45.0 parts by weight of the MQ silicone resin B-3, 36.8 parts by weight of toluene, 0.40 parts by weight of the dimethyl siloxane/methylhydrogen siloxane copolymer capped at both terminals with trimethylsiloxy groups C-1, and 0.20 parts by weight of the curing inhibitor E-1 were sufficiently mixed at room temperature, after which 0.36 parts by weight of the platinum based hydrosilylation reaction catalyst D was added to the mixture and was mixed well to form a curable organopolysiloxane composition. The molar ratio of SiH groups in component C-1 to the amount of alkenyl groups in component A-1 (SiH/Vi ratio) was 38.7, while the content of the platinum metal to the solid content was 33.6 ppm.

The composition was cured via the abovementioned method, after which the viscoelasticity was measured via the abovementioned method, with the evaluation results indicated in Table 3.

### Example 7

14.0 parts by weight of the vinyl functional polydimethylsiloxane gum A-1, 9.3 parts by weight of the non-functional (trimethylsilyl-capped) polydimethylsiloxane gum A′, 45.0 parts by weight of the MQ silicone resin B-3, 36.8 parts by weight of toluene, 0.40 parts by weight of the dimethyl siloxane/methylhydrogen siloxane copolymer capped at both terminals with trimethylsiloxy groups C-1, and 0.20 parts by weight of the curing inhibitor E-1 were sufficiently mixed at room temperature, after which 0.36 parts by weight of the platinum based hydrosilylation reaction catalyst D was added to the mixture and was mixed well to form a curable organopolysiloxane composition. The molar ratio of SiH groups in component C-1 to the amount of alkenyl groups in component A-1 (SiH/Vi ratio) was 45.2, while the content of the platinum metal to the solid content was 33.6 ppm.

The composition was cured via the abovementioned method, after which the viscoelasticity was measured via the abovementioned method, with the evaluation results indicated in Table 3.

### Ball-Dropping Test Result of Laminated Body Using Interlayer Adhesive Layer e.g., Obtained by Example 7

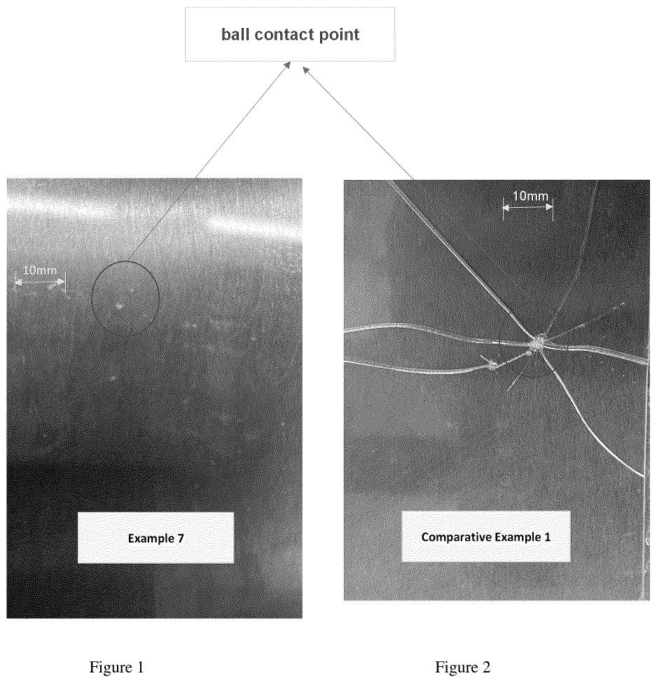

The pressure sensitive adhesive film of 120 μm in thickness with the dimension of 149 mm×69.5 mm was laminated in between a stainless steel sheet of 449 mm×430 mm×20 mm in dimension and a glass sheet of 149 mm×69.5 mm×0.342 mm in dimension using a plastic hand roller. This laminated body was placed horizontally with the stainless steel sheet at the bottom and the glass sheet at the top, followed by dropping a stainless steel ball of 11.11 mm in diameter, weighing 5.6 g, to the glass surface from the height of 300 mm. The impact resistance that the pressure sensitive adhesive film provides to the laminate was observed if the glass sheet breaks or not. The result was shown in FIG. 1.

### Example 8

11.7 parts by weight of the vinyl functional polydimethylsiloxane gum A-1, 11.7 parts by weight of the non-functional (trimethylsilyl-capped) polydimethylsiloxane gum A′, 45.0 parts by weight of the MQ silicone resin B-3, 36.8 parts by weight of toluene, 0.40 parts by weight of the dimethyl siloxane/methylhydrogen siloxane copolymer capped at both terminals with trimethylsiloxy groups C-1, and 0.20 parts by weight of the curing inhibitor E-1 were sufficiently mixed at room temperature, after which 0.36 parts by weight of the platinum based hydrosilylation reaction catalyst D was added to the mixture and was mixed well to form a curable organopolysiloxane composition. The molar ratio of SiH groups in component C-1 to the amount of alkenyl groups in component A-1 (SiH/Vi ratio) was 54.2, while the content of the platinum metal to the solid content was 33.6 ppm.

The composition was cured via the abovementioned method, after which the viscoelasticity was measured via the abovementioned method, with the evaluation results indicated in Table 3.

### Comparative Example 1

23.3 parts by weight of the vinyl functional polydimethylsiloxane gum A-1, 56.8 parts by weight of the MQ silicone resin B-1, 2.9 parts by weight of the MQ silicone resin B-3, 30.0 parts by weight of toluene, 0.25 parts by weight of the methylhydrogen siloxane polymer capped at both terminals with trimethylsiloxy groups C-2, and 0.15 parts by weight of the curing inhibitor E-1 were sufficiently mixed at room temperature, after which 1.08 parts by weight of the platinum based hydrosilylation reaction catalyst D was added to the mixture and was mixed well to form a curable organopolysiloxane composition. The molar ratio of SiH groups in component C-2 to the amount of alkenyl groups in component A-1 (SiH/Vi ratio) was 35.6, while the content of the platinum metal to the solid content was 78.7 ppm.

The composition was cured via the abovementioned method, after which the viscoelasticity was measured via the abovementioned method, with the evaluation results indicated in Table 3.

### Ball-Dropping Test Result of Laminated Body Using Interlayer Adhesive Layer e.g., Obtained by Comparative Example 1

The pressure sensitive adhesive film of 120 μm in thickness with the dimension of 149 mm×69.5 mm was laminated in between a stainless steel sheet of 449 mm×430 mm×20 mm in dimension and a glass sheet of 149 mm×69.5 mm×0.342 mm in dimension using a plastic hand roller. This laminated body was placed horizontally with the stainless steel sheet at the bottom and the glass sheet at the top, followed by dropping a stainless steel ball of 11.11 mm in diameter, weighing 5.6 g, to the glass surface from the height of 300 mm. The impact resistance that the pressure sensitive adhesive film provides to the laminate was observed if the glass sheet breaks or not. The result was shown in FIG. 2.

### Comparative Example 2

23.3 parts by weight of the vinyl functional polydimethylsiloxane gum A-1, 6.0 parts by weight of the vinyl functional polydimethylsiloxane gum A-2, 56.8 parts by weight of the MQ silicone resin B-1, 2.9 parts by weight of the MQ silicone resin B-3, 44.0 parts by weight of toluene, 0.32 parts by weight of the methylhydrogen siloxane polymer capped at both terminals with trimethylsiloxy groups C-2, and 0.18 parts by weight of the curing inhibitor E-1 were sufficiently mixed at room temperature, after which 1.17 parts by weight of the platinum based hydrosilylation reaction catalyst D was added to the mixture and was mixed well to form a curable organopolysiloxane composition. The molar ratio of SiH groups in component C-2 to the amount of alkenyl groups in components A-1 and A-2 (SiH/Vi ratio) was 36.8, while the content of the platinum metal to the solid content was 78.6 ppm.

The composition was cured via the abovementioned method, after which the viscoelasticity was measured via the abovementioned method, with the evaluation results indicated in Table 3.

### Comparative Example 3

23.3 parts by weight of the vinyl functional polydimethylsiloxane gum A-1, 13.5 parts by weight of the vinyl functional polydimethylsiloxane gum A-2, 56.8 parts by weight of the MQ silicone resin B-1, 2.9 parts by weight of the MQ silicone resin B-3, 61.4 parts by weight of toluene, 0.42 parts by weight of the methylhydrogen siloxane polymer capped at both terminals with trimethylsiloxy groups C-2, and 0.22 parts by weight of the curing inhibitor E-1 were sufficiently mixed at room temperature, after which 1.28 parts by weight of the platinum based hydrosilylation reaction catalyst D was added to the mixture and was mixed well to form a curable organopolysiloxane composition. The molar ratio of SiH groups in component C-2 to the amount of alkenyl groups in components A-1 and A-2 (SiH/Vi ratio) was 39.0, while the content of the platinum metal to the solid content was 78.5 ppm.

The composition was cured via the abovementioned method, after which the viscoelasticity was measured via the abovementioned method, with the evaluation results indicated in Table 3.

### Comparative Example 4

23.3 parts by weight of the vinyl functional polydimethylsiloxane gum A-1, 19.5 parts by weight of the vinyl functional polydimethylsiloxane gum A-2, 56.8 parts by weight of the MQ silicone resin B-1, 2.9 parts by weight of the MQ silicone resin B-3, 75.4 parts by weight of toluene, 0.44 parts by weight of the methylhydrogen siloxane polymer capped at both terminals with trimethylsiloxy groups C-2, and 0.25 parts by weight of the curing inhibitor E-1 were sufficiently mixed at room temperature, after which 1.38 parts by weight of the platinum based hydrosilylation reaction catalyst D was added to the mixture and was mixed well to form a curable organopolysiloxane composition. The molar ratio of SiH groups in component C-2 to the amount of alkenyl groups in components A-1 and A-2 (SiH/Vi ratio) was 35.4, while the content of the platinum metal to the solid content was 78.5 ppm.

The composition was cured via the abovementioned method, after which the viscoelasticity was measured via the abovementioned method, with the evaluation results indicated in Table 3.

### Comparative Example 5

21.0 parts by weight of the vinyl functional polydimethylsiloxane gum A-1, 91.5 parts by weight of the MQ silicone resin B-3, 51.4 parts by weight of toluene, 0.44 parts by weight of the dimethyl siloxane/methylhydrogen siloxane copolymer capped at both terminals with trimethylsiloxy groups C-1, and 0.10 parts by weight of the curing inhibitor E-1 were sufficiently mixed at room temperature, after which 1.33 parts by weight of the platinum based hydrosilylation reaction catalyst D was added to the mixture and was mixed well to form a curable organopolysiloxane composition. The molar ratio of SiH groups in component C-1 to the amount of alkenyl groups in component A-1 (SiH/Vi ratio) was 33.1, while the content of the platinum metal to the solid content was 79.7 ppm.

The composition was cured via the abovementioned method, after which the viscoelasticity was measured via the abovementioned method, with the evaluation results indicated in Table 3.

### Comparative Example 6

22.6 parts by weight of the vinyl functional polydimethylsiloxane gum A-2, 70.7 parts by weight of the MQ silicone resin B-2, 2.4 parts by weight of the MQ silicone resin B-3, 52.0 parts by weight of toluene, 0.23 parts by weight of the methylhydrogen siloxane polymer capped at both terminals with trimethylsiloxy groups C-2, and 0.21 parts by weight of the curing inhibitor E-2 were sufficiently mixed at room temperature, after which 1.13 parts by weight of the platinum based hydrosilylation reaction catalyst D was added to the mixture and was mixed well to form a curable organopolysiloxane composition. The molar ratio of SiH groups in component C-2 to the amount of alkenyl groups in component A-2 (SiH/Vi ratio) was 36.5, while the content of the platinum metal to the solid content was 81.2 ppm.

The composition was cured via the abovementioned method, after which the viscoelasticity was measured via the abovementioned method, with the evaluation results indicated in Table 3.

### Comparative Example 7

22.6 parts by weight of the vinyl functional polydimethylsiloxane gum A-2, 55.7 parts by weight of the MQ silicone resin B-2, 2.4 parts by weight of the MQ silicone resin B-3, 46.9 parts by weight of toluene, 0.23 parts by weight of the methylhydrogen siloxane polymer capped at both terminals with trimethylsiloxy groups C-2, and 0.21 parts by weight of the curing inhibitor E-2 were sufficiently mixed at room temperature, after which 0.98 parts by weight of the platinum based hydrosilylation reaction catalyst D was added to the mixture and was mixed well to form a curable organopolysiloxane composition. The molar ratio of SiH groups in component C-2 to the amount of alkenyl groups in component A-2 (SiH/Vi ratio) was 36.5, while the content of the platinum metal to the solid content was 81.6 ppm.

The composition was cured via the abovementioned method, after which the viscoelasticity was measured via the abovementioned method, with the evaluation results indicated in Table 3.

TABLE 2

| Components | | | | | | | | | | | | |
|---|---|---|---|---|---|---|---|---|---|---|---|---|
| (mass parts) | A-1 | A-2 | A′ | B-1 | B-2 | B-3 | C-1 | C-2 | E-1 | E-2 | D | Solvent |
| Example-1 | 21.0 | 3 | 0 | 0 | 0 | 53.5 | 0.44 | 0.05 | 0.12 | 0 | 0.97 | 47.0 |
| Example-2 | 21.0 | 0 | 0 | 0 | 0 | 53.5 | 0.44 | 0 | 0.10 | 0 | 0.92 | 40 |
| Example-3 | 21.0 | 0 | 0 | 0 | 0 | 71.5 | 0.44 | 0 | 0.10 | 0 | 1.12 | 45.4 |
| Example-4 | 0.0 | 25.0 | 0 | 0 | 45.7 | 2.4 | 0 | 0.28 | 0.01 | 0.21 | 0.91 | 49.09 |
| Example-5 | 0.0 | 27.4 | 0 | 0 | 45.7 | 2.4 | 0 | 0.33 | 0.02 | 0.21 | 0.95 | 54.68 |
| Example-6 | 16.3 | 0 | 7.0 | 0 | 0 | 45.0 | 0.40 | 0 | 0.2 | 0 | 0.36 | 36.8 |
| Example-7 | 14.0 | 0 | 9.3 | 0 | 0 | 45.0 | 0.40 | 0 | 0.2 | 0 | 0.36 | 36.8 |
| Example-8 | 11.7 | 0 | 11.7 | 0 | 0 | 45.0 | 0.40 | 0 | 0.2 | 0 | 0.36 | 36.8 |
| Comparative | 23.3 | 0 | 0 | 56.8 | 0 | 2.9 | 0 | 0.25 | 0.15 | 0 | 1.08 | 30 |
| example 1 | | | | | | | | | | | | |
| Comparative | 23.3 | 6 | 0 | 56.8 | 0 | 2.9 | 0 | 0.32 | 0.18 | 0 | 1.17 | 44.0 |
| example 2 | | | | | | | | | | | | |
| Comparative | 23.3 | 13.5 | 0 | 56.8 | 0 | 2.9 | 0 | 0.42 | 0.22 | 0 | 1.28 | 61.4 |
| example 3 | | | | | | | | | | | | |
| Comparative | 23.3 | 19.5 | 0 | 56.8 | 0 | 2.9 | 0 | 0.44 | 0.25 | 0 | 1.38 | 75.4 |
| example 4 | | | | | | | | | | | | |
| Comparative | 21.0 | 0 | 0 | 0 | 0 | 91.5 | 0.44 | 0 | 0.10 | 0 | 1.33 | 51.4 |
| example 5 | | | | | | | | | | | | |
| Comparative | 0.0 | 22.6 | 0 | 0 | 70.7 | 2.4 | 0 | 0.23 | 0 | 0.21 | 1.13 | 52 |
| example 6 | | | | | | | | | | | | |
| Comparative | 0.0 | 22.6 | 0 | 0 | 55.7 | 2.4 | 0 | 0.23 | 0 | 0.21 | 0.98 | 46.9 |
| example 7 | | | | | | | | | | | | |

TABLE 3

| | | | | | | | tan δ >0.5 |
|---|---|---|---|---|---|---|---|
| | | | | | | | temperature |
| | Temperature | tan δ values | | | | | range (° C.) |
| | at tan δ peak | peak | | | | | <width of tan |
| Examples | (° C.) | value | −50° C. | −20° C. | 25° C. | 100° C. | δ peak> |
| Example 1 | −25.9 | 1.71 | 0.843 | 1.516 | 0.218 | 0.077 | 68 |
| Example 2 | −15.6 | 1.76 | 0.577 | 1.677 | 0.4 | 0.09 | 74 |
| Example 3 | 21.7 | 1.91 | 0.279 | 0.66 | 1.799 | 0.149 | 87 |
| Example 4 | 6.6 | 1.08 | 0.36 | 0.75 | 0.719 | 0.17 | 71 |
| Example 5 | −5.8 | 1.02 | 0.419 | 0.775 | 0.602 | 0.127 | 72 |
| Example 6 | −40 | 1.73 | 1.37 | 0.83 | 0.22 | 0.21 | 63 |
| Example 7 | −38 | 1.74 | 1.305 | 0.92 | 0.28 | 0.28 | 67 |
| (No crack) | | | | | | | |
| Example 8 | −43 | 1.72 | 1.48 | 0.79 | 0.32 | 0.34 | 70 |
| Comparative 1 | 64.5 | 1.14 | 0.159 | 0.291 | 0.707 | 0.61 | 104 |
| (Crack) | | | | | | | |
| Comparative 2 | 40.6 | 1.15 | 0.23 | 0.45 | 1.06 | 0.256 | 94 |
| Comparative 3 | −17.7 | 0.98 | 0.551 | 0.978 | 0.3 | 0.069 | 76 |
| Comparative 4 | −43.6 | 0.76 | 0.7 | 0.557 | 0.145 | 0.06 | 66 |
| Comparative 5 | 46.8 | 1.80 | 0.168 | 0.365 | 1.137 | 0.485 | 105 |
| Comparative 6 | 61.7 | 1.48 | 0.17 | 0.325 | 0.846 | 0.675 | 115 |
| Comparative 7 | 45 | 1.34 | 0.21 | 0.4 | 1.03 | 0.466 | 108 |

As indicated in Table 3, the silicone-based PSA layer-forming compositions according to Examples 1 to 8 provided an interlayer adhesive layer, of which the temperature at the tan δ peak was below 35° C., and the tan δ value at the peak was greater than 1.0. The electronic articles using the interlayer adhesive layer obtained by the compositions according to Examples 1 to 8 in its constructions were anticipated to be sufficiently bonded/assembled between its functional layers to achieve better damping/shock-absorption property in said interlayer adhesive layer. Specifically, as shown in FIG. 1 of ball-dropping test onto the lamination body using example 7, there was no crack or damage observed in the lamination body having the interlayer adhesive layer relating to this invention.

In contrast, in Comparative Examples 1 to 8, the interlayer adhesive layer satisfying the required property in this invention was not obtained. The electronic articles using the interlayer adhesive layer obtained by the compositions according to comparative examples 1 to 7 in its constructions were anticipated to have insufficient damping/shock-absorption property in said interlayer adhesive layer. As shown in FIG. 2 of ball-dropping test onto the lamination body using comparative example 1, ball-dropping resulted in huge and critical crack observed in the lamination body.

1. An electronic article having an interlayer adhesive layer, of which a temperature at tan δ peak is below 35° C., and tan δ value at peak is greater than 1.0, as measured by a dynamic mechanical analysis rheometer using a parallel plate measuring system at 1 Hz.

2. The electronic article according to claim 1, wherein width of the tan δ peak of the interlayer adhesive layer, as defined by absolute value of temperature range where the tan δ value exceeds 0.5, is narrower than 90° C.

3. The electronic article according to claim 1, wherein tan δ curve of the interlayer adhesive layer as measured by a dynamic mechanical analysis rheometer using a parallel plate measuring system at 1 Hz meets following conditions:
i) the temperature at the tan δ peak is positioned from −50° C. to 25° C.; and
ii) the width of the tan δ peak, as defined by the absolute value of temperature range where the tan δ value exceeds 0.5, ranges from 50° C. to below 90° C.

4. The electronic article according to claim 1, wherein the interlayer adhesive layer is a pressure sensitive silicone adhesive layer obtained by curing a silicone-based pressure sensitive adhesive-forming composition comprising:
(A) a linear organopolysiloxane having greater than one alkenyl group on average per molecule;
(B) an organopolysiloxane resin, wherein the total content of hydroxyl groups and hydrolysable groups with respect to all silicon atoms in the molecule is 9 mole % or less;
(C) an organohydrogenpolysiloxane having at least two Si—H bonds per molecule; and
(D) a hydrosilylation reaction catalyst.

5. The electronic article according to claim 4, wherein:
at least a portion of component (A) is (A1) a raw rubber-like alkenyl group-containing organopolysiloxane having a viscosity of 100,000 mPa·s or more at 25° C. or having a plasticity number within a range of 50 to 200 as measured in accordance with a method as described in JIS K6249, and the content of a vinyl (CH₂═CH—) moiety of alkenyl group is within a range of 0.005 to 0.400 mass %;
component (B) is (B1) an organopolysiloxane resin or mixture thereof which consists essentially of R₃SiO_{1/2} units and SiO_{4/2} units, where R is a monovalent organic group and 90 mole % or more of R is an alkyl group having 1 to 6 carbon atoms or a phenyl group;
component (C) is present in an amount such that the molar ratio of the amount of SiH groups in the component (C) to the total amount of the alkenyl groups in components (A) and (B) is 1 to 100; and
component (D) is a platinum-based catalyst and is present in an amount such that the content of a platinum based metal in a solid content of the composition is within a range of 0.1 to 200 ppm in the silicone-based pressure sensitive adhesive-forming composition excluding solvents.

6. The electronic article according to claim 4, wherein component (C) is present in an amount such that the molar ratio of the amount of SiH groups in component (C) to the total amount of the alkenyl groups in components (A) and (B) is 10 to 60.

7. The electronic article according to claim 4, wherein the silicone-based pressure sensitive adhesive-forming composition further comprises (A′) a linear organopolysiloxane which does not contain a carbon-carbon double bond-containing reactive group in the molecule.

8. The electronic article according to claim 1, wherein the interlayer adhesive layer is arranged between two functional layers to bond or assemble the two functional layers with providing impact resistance to the electronic article as a damping/shock-absorption layer.

9. The electronic article according to claim 1, wherein the interlayer adhesive layer is substantively transparent and arranged between two functional layers, in which at least one of the functional layers is substantively transparent, to bond or assemble the two functional layers with providing impact resistance to the electronic article as a damping/shock-absorption layer.

10. The electronic article according to claim 1, wherein the electronic article is a display device having a structure that displaying unit is directly bonded or assembled to other functional unit through said interlayer adhesive layer with providing impact resistance to the electronic article as a damping/shock-absorption layer.

11. The electronic article according to claim 1, wherein a thickness of the interlayer adhesive layer ranges from 1 to 1000 μm, and the interlayer adhesive layer is arranged between two functional layers to bond or assemble the two functional layers as a single adhesive layer with providing impact resistance to the electronic article as a damping/shock-absorption layer in the electronic article.

12. The electronic article according to claim 1, wherein the electronic article is substantively free of any additional interlayer damping/shock-absorption layers arranged between two functional layers, other than the interlayer adhesive layer of which the temperature at the tan δ peak is below 35° C., and the tan δ value at the peak is greater than 1.0, as measured by a dynamic mechanical analysis rheometer using a parallel plate measuring system at 1 Hz.

13. A manufacturing process for the electronic article according to claim 1, comprising a step of assembling or bonding at least two functional layers with the interlayer adhesive layer, of which the temperature at the tan δ peak is below 35° C. and the tan δ value at the peak is greater than 1.0, as measured by a dynamic mechanical analysis rheometer using a parallel plate measuring system at 1 Hz.

14. An electronic article having an interlayer adhesive layer as a damping/shock-absorption layer, wherein the interlayer adhesive layer has a temperature at tan δ peak being below 35° C. and a tan δ value at the peak being greater than 1.0, as measured by a dynamic mechanical analysis rheometer using a parallel plate measuring system at 1 Hz.

15. The electronic article according to claim 14, wherein there is a single interlayer adhesive layer between two functional layers in the electronic articles, without any additional interlayer foam layers or damping/shock-absorption layers.
